(19) United States
(12) Patent Application Publication
(10) Pub. No.: US 2024/0062506 A1
(43) Pub. Date: Feb. 22, 2024

(54) OBJECT DETECTION DEVICE, OBJECT DETECTION METHOD, AND OBJECT DETECTION PROGRAM

(71) Applicant: NIPPON TELEGRAPH AND TELEPHONE CORPORATION, Tokyo (JP)

(72) Inventors: Hiroyuki UZAWA, Tokyo (JP); Saki HATTA, Tokyo (JP); Shuhei YOSHIDA, Tokyo (JP); Daisuke KOBAYASHI, Tokyo (JP); Yuya OMORI, Tokyo (JP); Ken NAKAMURA, Tokyo (JP); Koyo NITTA, Tokyo (JP)

(73) Assignee: NIPPON TELEGRAPH AND TELEPHONE CORPORATION, Tokyo (JP)

(21) Appl. No.: 18/265,881

(22) PCT Filed: Dec. 9, 2020
(86) PCT No.: PCT/JP2020/045847

§ 371 Date: Jun. 7, 2023

(51) Int. Cl. G06V 10/26; G06T 3/40; G06V 10/22

(52) U.S. Cl. CPC G06V 10/267; G06T 3/40; G06V 10/225; G06V 10/273; G06V 2201/10

(57) ABSTRACT

An object detection device 10 includes an entire processing unit 110 that obtains first metadata for the entire input image by scaling the input image and performing object detection processing, a divided image narrowing unit 120 that narrows down the input image into a predetermined number of selected divided images from a group of divided images obtained by dividing the input image, a division processing unit 130 that obtains second metadata by performing object detection processing for each of the selected divided images, and a synthesis processing unit 140 that removes the second metadata obtained by the division processing unit 130 that overlaps the first metadata obtained by the entire processing unit 110, and synthesizes the first metadata not removed and the first meta data obtained by the entire processing unit 110 to output the meta data.

### TECHNICAL FIELD

The disclosed technology relates to an object detection device, an object detection method, and an object detection program.

### BACKGROUND ART

In recent years, a technique for detecting an object at a high speed using deep learning has been proposed. YOLO (You Only Look Once) and SSD (Single Shot multibox Detector) are known as typical models using a Single-stage method for processing region extraction and category identification simultaneously at a high speed in one network (see NPL 1 and NPL 2). This kind of object detection technique is being considered for use in surveillance cameras, AI image processing in edge computing, and the like.

In the object detection based on the deep learning, the input image size is limited. For example, in object detection using YOLOv3 described in NPL 1, an input image is used which is obtained by resizing the size of an original image in either of 320 (width)×320 (height) pixels, 416×416 pixels, or 608×608 pixels.

For example, if the original image is a high-definition image such as full HD (1920×1080 pixels) or 4K (3840×2160 pixels), it is necessary to reduce the size of the image under the above-mentioned image size restrictions. By reducing the size of the high-definition image, characteristic portions of an object included in the image are also reduced in size, and therefore it may be difficult to detect an object that is relatively small with respect to the input image.

In view of this, for example, NPL 3 discloses a technique in which an input image is divided into a plurality of images and object detection is performed on each of the divided images.

### CITATION LIST

### Non Patent Literature

[NPL 1] Joseph Redmon and Ali Farhadi, “YOLOv3: An Incremental Improvement”, https://arxiv.org/abs/1804.02767 (https://arxiv.org/pdf/1804.02767.pdf)
[NPL 2] Wei Liu et al., “SSD: Single Shot MultiBox Detector”, https://arxiv.org/abs/1512.02325 (https://arxiv.org/pdf/1512.02325.pdf)
[NPL 3] Vit Ruzicka and Franz Franchetti, “Fast and accurate object detection in high resolution 4K and 8K video using GPUs”, 2018 IEEE High Performance extreme Computing Conference (HPEC)

### SUMMARY OF INVENTION

### Technical Problem

However, for a relatively large object that straddles divided images, the characteristic portion of the object is also divided, and therefore it may be difficult to detect a small object for an input image.

The disclosed technology has been made in view of the above points and has an object of providing an object detection device, an object detection method, and an object detection program capable of correctly detecting an object included in an input image, even when a relatively small object is included for the input image.

### Solution to Problem

A first aspect of the present disclosure is an object detection device that outputs metadata from an input image that includes at least the attributes, confidence level, center coordinates, and frame surrounding the object in the input image, and comprises:
an entire processing unit that performs object detection processing by scaling the input image, thereby obtains first metadata for the entire input image;
a divided image narrowing unit that narrows down the input image into a predetermined number of selected divided images from a group of divided images obtained by dividing the input image;
a division processing unit that obtains second metadata for each of the selected divided images by performing object detecting processing on each of the selected divided images;
and a synthesis processing unit that removes the second metadata obtained by the division processing unit that overlaps the first metadata obtained by the entire processing unit, and synthesizes the first metadata that has not been removed and the first metadata obtained by the entire processing unit to output the metadata.

A second aspect of the present disclosure is an object detection method for outputting metadata from an input image that includes at least the attributes, confidence level, center coordinates, and frame surrounding the object in the input image, and a computer executes a process wherein:
the computer obtains first metadata for an entire input image by scaling the input image to perform object detection processing;
narrows down the input image into a predetermined number of selected divided images from a group of divided images obtained by dividing the input image;
obtains second metadata for each of the selected divided images, by performing object detection processing to each of the selected divided images;
removes the obtained second metadata overlapping the obtained first metadata;
and synthesizes the first metadata not removed with the obtained first metadata to output the metadata.

A third aspect of the present disclosure is an object detection program, and causes a computer to function as an object detection device according to the first aspect of the present disclosure.

### Advantageous Effects of Invention

According to the disclosed technique, an object detection device, an object detection method and an object detection program can be provided, wherein it is capable of detecting an object included in an input image with high accuracy even when a relatively small object is included in the input image by narrowing down a divided image group into a predetermined number of selected divided images and detecting the object.

### BRIEF DESCRIPTION OF DRAWINGS

FIG. 1 is an overview of the first embodiment of the object detection device.

FIG. 2 is a block diagram illustrating a hardware configuration of the object detection device.

FIG. 3 is a block diagram showing an example of a functional configuration of the object detection device that is the premise of the first embodiment of the object detection device.

FIG. 4 is a block diagram showing an example of a functional configuration of the object detection device according to the first embodiment.

FIG. 5 is a flowchart showing the flow of object detection processing by the object detection device.

FIG. 6 is a flowchart showing the details of the entire image processing.

FIG. 7 is a flowchart showing the details of the divided image narrowing processing.

FIG. 8 is a flowchart showing an example of the divided image processing.

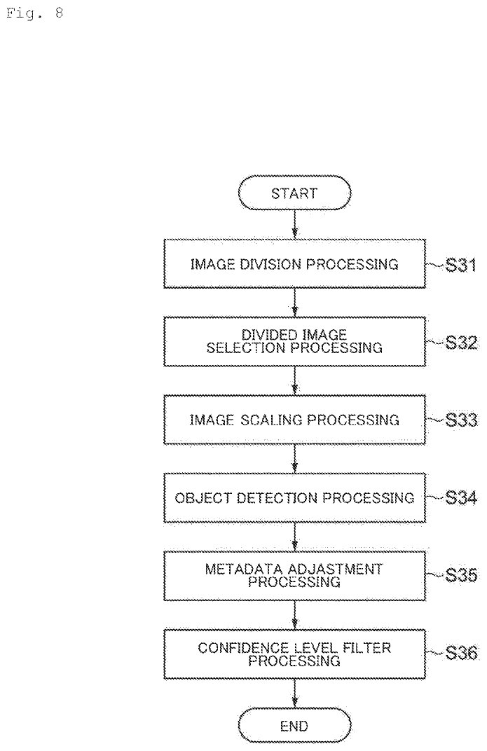

FIG. 9 is a flowchart showing the detail of the synthesizing processing.

FIG. 10 is a flowchart showing the detail of an estimated interpolation object number calculation processing.

FIG. 11 is a diagram showing divided areas of a divided image.

FIG. 12 is a block diagram showing an example of a functional configuration of the object detection device according to the third embodiment.

FIG. 13 is a block diagram showing an example of a functional configuration of the object detection device according to the fourth embodiment.

### DESCRIPTION OF EMBODIMENTS

Example embodiments of the technology in the disclosure will be described below with reference to the figures. Note that in the figures, identical or equivalent constituent elements and parts have been allocated identical reference symbols. Further, dimension ratios in the figures have been exaggerated to facilitate the description and may therefore differ from the actual ratios.

### First Embodiment

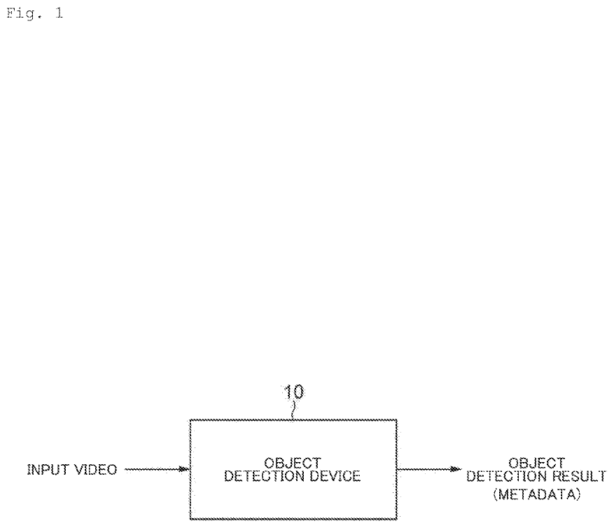

FIG. 1 is an overview of the first embodiment of the object detection device. The object detection device 10 shown in FIG. 1 executes object detection processing for an image input. Then, the object detection device 10 outputs an object detection result by the object detection processing by metadata. The object detection device 10, from an input image as picture input, outputs metadata which includes at least the attributes, confidence level, center coordinates, and frame surrounding the object in the input image.

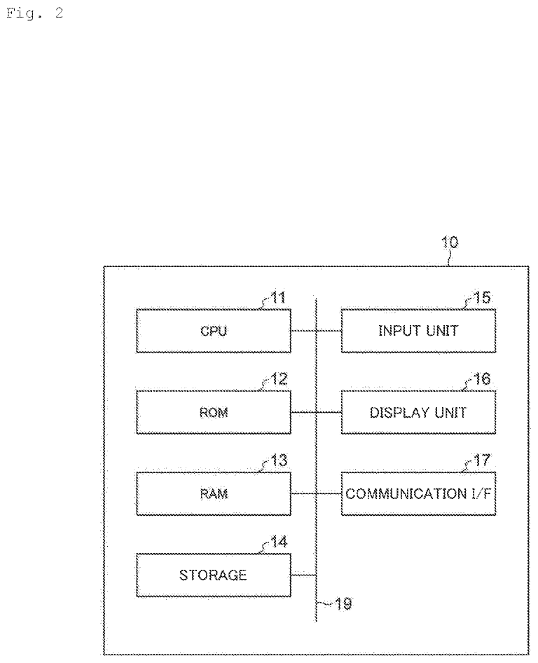

FIG. 2 is a block diagram showing the hardware configurations of the object detection device 10.

As shown in FIG. 2, the object detection device 10 has a CPU (Central Processing Unit) 11, a ROM (Read Only Memory) 12, a RAM (Random Access Memory) 13, a storage 14, an input unit 15, a display unit 16, and a communication interface (I/F) 17. The respective configurations are connected to each other communicably by a bus 19.

The CPU 11 is a central calculation processing unit that executes various programs and controls the respective units. More specifically, the CPU 11 reads a program from the ROM 12 or the storage 14 and executes the program using the RAM 13 as a working area. The CPU 11 controls the respective configurations described above and performs various types of calculation processing in accordance with the program stored in the ROM 12 or the storage 14. In the embodiment, the ROM 12 or the storage 14 stores an object detection program for detecting an object in an input image.

Various programs and various types of data are stored in the ROM 12. A program or data is temporarily stored in the RAM 13 that serves as a work area. The storage 14 is constituted by a storage device such as a HDD (Hard Disk Drive) or a SSD (Solid State Drive), and various programs including an operating system and various types of data are stored in the storage 14.

The input unit 15 includes a pointing device such as a mouse and a keyboard, and is used to input various types of input.

The display unit 16 is a liquid crystal display, for example, and displays various information. The display unit 16 may also function as an input unit 15 by employing a touch panel scheme.

The communication interface 17 is an interface for performing communication with other equipment. In the communication, a wired communication standard such as Ethernet (registered trademark) and FDDI or a wireless communication standard such as 4G, 5G, and WiFi (registered trademark) is used.

Next, the functional configurations of the object detection device 10 will be described. Before describing the functional configuration of the object detection device 10 according to the first embodiment, the functional configuration of the object detection device which is a premise of the object detection device 10 according to the first embodiment will be described.

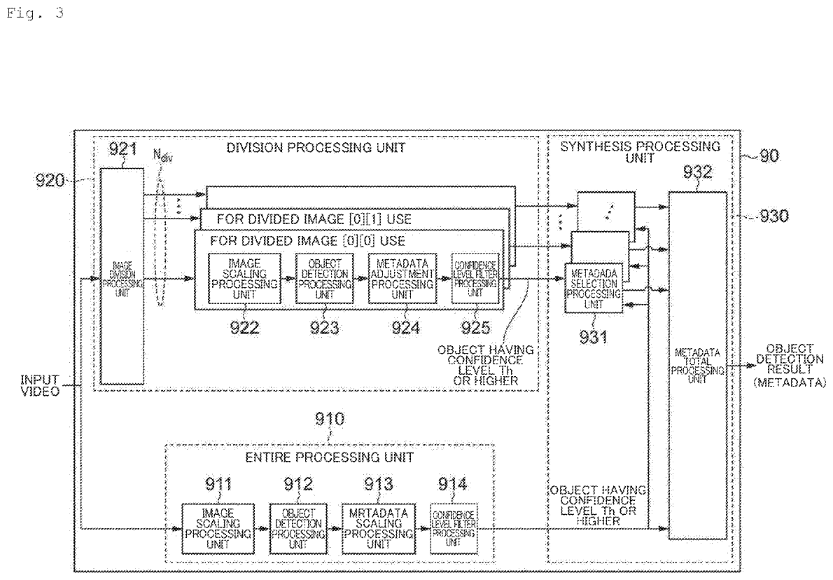

FIG. 3 is a block diagram showing the functional configuration of the object detection device 90 that is a premise of the object detection device 10 according to the first embodiment of the present invention.

As illustrated in FIG. 3, the object detection device 90 includes an entire processing unit 910, a division processing unit 920, and a synthesis processing unit 930 as functional components.

The entire processing unit 910 includes an image scaling processing unit 911, an object detection processing unit 912, a metadata scaling processing unit 913, and a confidence level filter processing unit 914.

An image scaling processing unit 911 reduces an input image input as a picture input, to an image size that can be input to object detection processing based on a deep learning result. The image scaling processing unit 911 can reduce the image size while maintaining the ratio of the width and the height of the input image. The reduction is based, for example, on a bilinear interpolation method. An input image input as a video input is, for example, an image captured by an imaging device not shown in the figure.

The object detection processing unit 912 inputs the input image reduced by the image scaling processing unit 911, and computes a learned object detection model based on predetermined deep learning. The object detection processing unit 912 provides the reduced input image as input to the object detection model prepared in advance, performs the computation of the object detection model, and generates a set of pieces of attribute information including the attribute value of the object included in the input image and a frame surrounding the object, as the metadata of the input image. The frame surrounding the object includes at least center coordinates (X, Y), a frame height (H), and a frame width (W).

Also, the object detection unit 912 detects objects in the input image by using, for example, an object detection model such as YOLO using a convolutional neural network (CNN) learned in advance by a computation apparatus such as an external server.

The metadata scaling processing unit 913 performs scaling processing for enlarging the frame surrounding the object included in the metadata of the input image generated by the object detection processing unit 912 to correspond to the size of the input image before reduction. This is because the metadata generated by the object detection processing unit 912 is for the reduced input image.

A confidence level filter processing unit 914 selects an object whose confidence level is equal to or more than a preset threshold Th from the detection object group after the metadata scaling processing unit 913 has scaled. A confidence level filter processing unit 914 sends an object whose confidence level is equal to or more than a threshold Th to a synthesis processing unit 930.

The division processing unit 920 includes an image division processing unit 921, an image scaling processing unit 922, an object detection processing unit 923, a metadata adjustment processing unit 924 and a confidence level filter processing unit 925.

The image division processing unit 921 divides the input image into a plurality of divided images [i][j] (0≤i≤Nw−1, 0≤j≤Nh−1), with a number of divisions Nw in the width direction and a number of divisions Nh in the height direction of the input image.

The image scaling processing unit 922 performs scaling processing for reducing the size of each of the plurality of divided images [i][j] to a specified image size that can be input to an object detection model based on deep learning. The image scaling processing unit 922 reduces the image size while maintaining parameter values such as the ratio between the width and height of each divided image so as to correspond to the size of the input image of the object detection model used by a later-described the object detection processing unit 923.

The object detection processing unit 923 inputs the divided image reduced by the image scaling processing unit 922, and computes a learned object detection model based on predetermined deep learning. The object detection processing unit 923 provides the reduced image as input to the object detection model prepared in advance, performs the computation of the object detection model, and generates a set of pieces of attribute information including the attribute value of the object included in the divided image and a frame surrounding the object as the metadata of the divided image. The frame surrounding the object includes at least center coordinates (X, Y), a frame height (H), and a frame width (W).

The object detection processing unit 923 detects objects in the divided image by using, for example, an object detection model such as YOLO using a convolutional neural network (CNN) learned in advance by a computation apparatus such as an external server.

The metadata adjustment processing unit 924 performs adjustment processing of the metadata for mapping the frame surrounding the object detected by the object detection processing unit 923 to the original undivided image, that is, the input image.

A confidence level filter processing unit 925 selects an object whose confidence level is equal to or more than a preset threshold Th from the detection object group after the metadata adjustment processing unit 924 adjusts the metadata. The confidence level filter processing unit 925 sends an object whose confidence level is equal to or more than a threshold Th to a synthesis processing unit 930.

A synthesis processing unit 930 performs processing for interpolating the object not detected by the entire processing unit 910 with the object detected by the division processing unit 920. The synthesis processing unit 930 includes a metadata selection processing unit 931 and a metadata total processing unit 932.

A metadata selection processing unit 931 determines the coincidence between the object detected by the entire processing unit 910 and the object detected by the division processing unit 920, and outputs the non-coincident object as an interpolation object.

The metadata total processing unit 932 outputs the output from the metadata selection processing unit 931 for each divided image and the output from the entire processing unit 910 together as a final object detection result.

The object detection device 90 shown in FIG. 3 can detect both large and small objects at a time even for a high definition video exceeding the input constraint size of object detection based on deep learning. However, when an ultra-high definition video of 4K or more is inputted as a video input, the number of image divisions in the division processing unit 920 is large and the calculation amount becomes huge. For example, in the case of YOLOv3, even in the case of YOLO having the maximum input constraint size, the maximum number of divided images becomes 18, and the amount of calculation becomes huge.

The object detection device 10 according to the present embodiment can accurately detect both large and small objects at a time while suppressing an increase in calculation amount even when an ultra-high definition video of 4K or more is input as an video input.

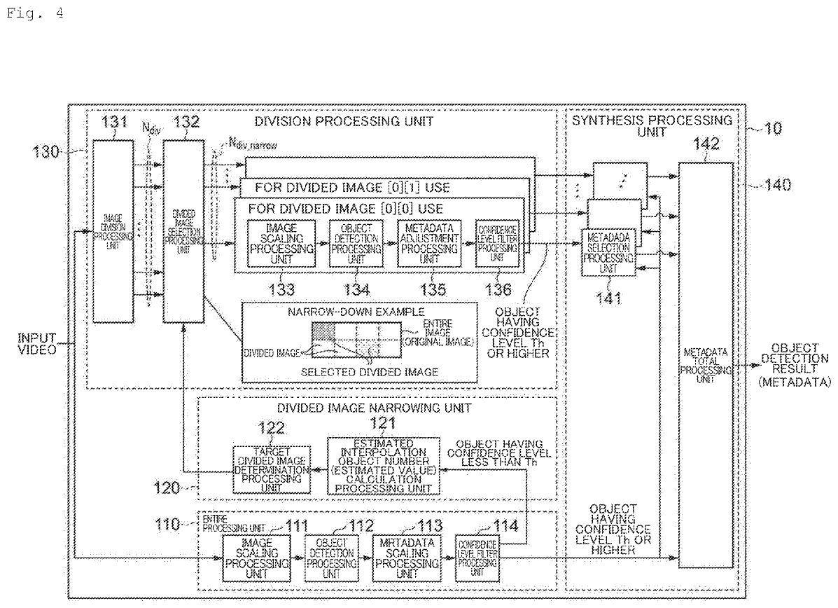

FIG. 4 is a block diagram showing an example of the functional configuration of the object detection device 10 according to the first embodiment.

As illustrated in FIG. 4, the object detection device 10 according to the first embodiment includes an entire processing unit 110, a divided image narrowing unit 120, a division processing unit 130, and a synthesis processing unit 140 as functional components. The respective function configurations are realized when the CPU 11 reads the object detection program stored in the ROM 12 or the storage 14 and develops and performs the read program on the RAM 13.

The entire processing unit 110 includes an image scaling processing unit 111, an object detection processing unit 112, a metadata scaling processing unit 113, and a confidence level filter processing unit 114.

The image scaling processing unit 111 executes scaling processing for reducing an input image input as video input to an image size that can be input to object detection processing based on a deep learning result. The image scaling processing unit 111 can reduce the image size while maintaining the ratio of the width and the height of the input image. An input image input as a video input is, for example, an image captured by an imaging device not shown in the figure.

The object detection processing unit 112 inputs the input image reduced by the image scaling processing unit 111 as object detection processing, and computes a learned object detection model based on predetermined deep layer learning. The object detection processing unit 112 provides the reduced image as input to the object detection model prepared in advance, performs the computation of the object detection model, and generates a set of pieces of attribute information including the attribute value of the object included in the overall image and a frame surrounding the object as the metadata of the overall image (first metadata). A frame surrounding the object included in the metadata is referred to as ‘quadrangular frame BB1’. Here, the quadrangular frame BB1 includes at least center coordinates (X, Y), a frame height (H), and a frame width (W).

The object detection processing unit 112 detects objects in the input image by using, for example, an object detection model such as YOLO using a convolutional neural network (CNN) learned in advance by a computation apparatus such as an external server.

The metadata scaling processing unit 113 performs scaling processing for enlarging the region of the quadrangular frame BB1 of the object included in the metadata of the input image generated by the object detection processing unit 112 to correspond to the size of the input image before reduction. This is because the metadata generated by the object detection processing unit 112 is for the reduced input image. The metadata scaling processing unit 113 performs scaling of the quadrangular frame BB1 included in the metadata of the input image using, for example, a bilinear interpolation method.

For example, it is assumed that the width of the input image is Wᵢₙ, the height is Hᵢₙ, the width of the input image reduced by the image scaling processing unit 111 is W_{det}, and the height is H_{det}. In this case, the metadata scaling processing unit 113 maps the quadrangular frame BB1 to the input image that is the original image by scaling the center coordinates (X_{bb}, Y_{bb}) of the quadrangular frame BB1 to (X_{bb}×Wᵢₙ/W_{det}, Y_{bb}×Hᵢₙ/H_{det}), and scaling the width W_{bb} and height H_{bb} of the quadrangular frame BB1 to W_{bb}×Wᵢₙ/W_{det}, H_{bb}×Hᵢₙ/H_{det}.

The confidence level filter processing unit 114 performs confidence level filter processing for selecting an object whose confidence level is equal to or more than a preset threshold Th for the detection object group after the metadata scaling processing unit 113 performs the scaling. The confidence level filter processing unit 114 sends an object whose confidence level is equal to or more than a threshold Th to a synthesis processing unit 140.

The confidence level filter processing unit 114 sends an object whose confidence level is less than a threshold th to a divided image narrowing unit 120.

The divided image narrowing unit 120 performs processing for narrowing down an input image into a predetermined number of selected divided images from a divided image group obtained by dividing the input image. The divided image narrowing unit 120 includes an estimated interpolation object number calculation processing unit 121 and an target divided image determination processing unit 122.

The estimated interpolation object number calculation processing unit 121 performs estimated interpolation object number calculation processing for calculating the estimated interpolation object number which is an estimation value of the interpolation object number from an object whose confidence level is less than a threshold Th. The estimated interpolation object number calculation processing will be described later. The estimated interpolation object number calculation processing unit 121 uses an object detection result of the entire processing unit 110 in the immediately preceding frame for calculation of the estimated value. Specifically, since the confidence level is less than the threshold Th in the entire processing unit 110, the object group excluded from the detection result is extracted and distributed to the corresponding divided region (the target coordinate range of the divided image with respect to the original input image).

The target divided image determination processing unit 122 performs target divided image determination processing for determining a divided image to be processed in the division processing unit 130 on the basis of the estimated interpolation object number calculated by the estimated interpolation object number calculation processing unit 121. The processing for determining the divided image to be processed by the division processing unit 130 will be described later.

The division processing unit 130 includes an image division processing unit 131, a divided image selection processing unit 132, an image scaling processing unit 133, an object detection processing unit 134, a metadata adjustment processing unit 135 and a confidence level filter processing unit 136.

The image division processing unit 131 divides the input image into N_{div} pieces of divided images [i][j] (0≤i≤N_{w}−1, 0≤j≤Nₕ−1), with a number of divisions N_{w} in the width direction and a number of divisions Nₕ in the height direction of the input image.

The divided image selection processing unit 132 performs divided image selection processing for selecting N_{div_narrow} (N_{div}≥N_{div_narrow}) pieces of divided image determined by the target divided image determination processing unit 122 from the divided image output by the division processing unit 130.

The image scaling processing unit 133 performs scaling processing for reducing the size of each of the divided images [i][j] which is divided by the image division processing unit 131 and selected by the divided image selection processing unit 132 to a specified image size that can be input to an object detection model based on deep learning. The image scaling processing unit 133 reduces the image size while maintaining parameter values such as the ratio between the width and height of each divided image so as to correspond to the size of the input image of the object detection model used by a later-described object detection processing unit 134.

The object detection processing unit 134 inputs the divided image reduced by the image scaling processing unit 133 as object detection processing, and computes a learned object detection model based on predetermined deep learning. The object detection processing unit 134 provides the reduced image as input to the object detection model prepared in advance, performs the computation of the object detection model, and generates a set of pieces of attribute information including the attribute value of the object included in the overall image and a frame surrounding the object as the metadata of the divided image (second metadata). The frame surrounding the object included in the metadata is referred to as ‘quadrangular frame BB2’. The quadrangular frame BB2 includes at least center coordinates (X, Y), a frame height (H), and a frame width (W).

The object detection processing unit 134 detects objects in the divided image by using, for example, an object detection model such as YOLO using a convolutional neural network (CNN) learned in advance by a computation apparatus such as an external server.

Here, it is assumed that the size of the input image is Wᵢₙ (width)×Hᵢₙ (height), and the designated image size that can be input to the object detection model prepared in advance is W_{det} (width)×H_{det} (height). In this case, the number of divisions N_{w} in the width direction and the number of divisions Nₕ in the height direction of the input image are provided by the following expressions (1) and (2). In the above equations (1) and (2), N_{w_max} indicates the upper limit of the number of divisions of the input image in the width direction, and N_{h_max} indicates the upper limit of the number of divisions of the input image in the height direction.

N_{w}=min(N_{w_max},ceiling(Wᵢₙ/W_{det})) (1)

Nₕ=min(N_{h_max},ceiling(Hᵢₙ/H_{det})) (2)

The metadata adjustment processing unit 135 performs adjustment processing of the metadata for mapping the quadrangular frame BB2 of the object detected by the object detection processing unit 134 to the original undivided image, that is, the input image. More specifically, it is assumed that the center coordinates of the quadrangular frame BB2 of the object detected in divided images [i][j] are (x_{bb_div}, y_{bb_div}), the width is w_{bb_div}, and the height is h_{bb_div}, and that the center coordinates of the frame adjusted to the coordinates of the original image are (x_{bb}, y_{bb}), the width is w_{bb}, and the height is h_{bb}. The metadata adjustment processing unit 135 maps the quadrangular frame BB2 to the input image based on the following expressions.

x_{bb}=x_{bb_div}×floor(Wᵢₙ/N_{w})+floor(Wᵢₙ/N_{w})×i (3)

y_{bb}=y_{bb_div}×floor(Hᵢₙ/Nₕ)+floor(Hᵢₙ/Nₕ)×j (4)

w_{bb}=w_{bb_div}×floor(Wᵢₙ/N_{w}) (5)

h_{bb}=h_{bb_div}×floor(Hᵢₙ/Nₕ) (6)

The confidence level filter processing unit 136 performs confidence level filter processing for selecting an object whose confidence level is equal to or more than a preset threshold Th with respect to the detection object group after the metadata adjustment processing unit 135 adjusts the metadata. The confidence level filter processing unit 136 sends an object whose confidence level is equal to or more than a threshold Th to a synthesis processing unit 140.

The synthesis processing unit 140 performs processing for interpolating the object not detected by the entire processing unit 110 with the object detected by the division processing unit 130. The synthesis processing unit 140 includes a metadata selection processing unit 141 and a metadata total processing unit 142.

The metadata selection processing unit 141 performs matching determination between the object detected by the entire processing unit 110 and the object detected by the division processing unit 130, and performs metadata selection processing for outputting the non-matching object as an interpolation object. The metadata selection processing performed by the metadata selection processing unit 141 will be described.

The metadata selection processing unit 141 compares metadata of one divided image among the plurality of divided images with metadata of the entire image, and determines whether or not an attribute value of the metadata of the entire image coincides with an attribute value of the metadata of the divided image. When they match, a metadata selection processing unit 141 calculates the degree of duplication. More specifically, the metadata selection processing unit 141 calculates the overlap degree obtained by dividing the area in which the quadrangular frame BB1 included in the metadata of the entire image and the quadrangular frame BB2 included in the metadata of the divided image overlap each other by the area of the quadrangular frame BB2. When they match, the metadata selection processing unit 141 similarly determines whether or not the different divided images match.

Next, if the overlap degree exceeds the pre-set threshold value, the metadata selection processing unit 141 determines that the attribute information of the metadata of the divided image and the attribute information of the metadata of the entire image is the same attribute information, and the attribute information that is the same is removed from the metadata of the divided image.

The metadata total processing unit 142 performs metadata total processing for outputting the output from the metadata selection processing unit 141 to each divided image and the output of the entire processing unit 110 together as a final object detection result. That is, the metadata total processing unit 142 generates the metadata of the input image by interpolating the metadata of the entire image with the metadata of the divided image from which the overlapping attribute information is excluded.

The object detection device 10 shown in FIG. 4 can detect both large and small objects at a time even for a high definition video exceeding the input constraint size of object detection based on deep learning. The object detection device 10 narrows down the divided images to be processed even when an ultrahigh definition video such as 4K is input, so that both large and small objects can be detected at a time with high accuracy while suppressing an increase in calculation amount.

Next, the operation of the object detection device 10 will be described.

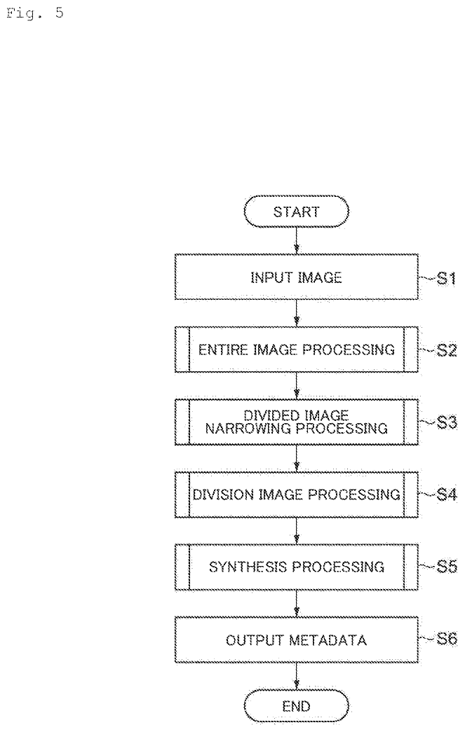

FIG. 5 is a flowchart showing the flow of object detection processing by the object detection device 10. The object identification processing is started when the CPU 11 reads the object detection program from the ROM 12 or the storage 14 and develops and performs the program on the RAM 13.

In step S1, the CPU 11 functions as the entire processing unit 110 and the division processing unit 130, and then acquires the input image from the outside.

Following the step S1, in a step S2, the CPU 11 performs entire image processing which is object detection processing to the entire input image as an entire processing unit 110.

Following the step S2, in a step S3, the CPU 11 executes divided image narrowing-down processing as a divided image narrowing unit 120.

Following the step S3, in a step S4, the CPU 11 executes divided image processing which is object detection processing to the divided image as a division processing unit 130.

Following the step S4, in a step S5, the CPU 11, as a synthesis processing unit 140, performs synthesis processing for synthesizing the metadata generated by the entire image processing and the metadata generated by the division image processing.

Following the step S5, in a step S6, the CPU 11 outputs the metadata generated by the synthesis processing to the outside.

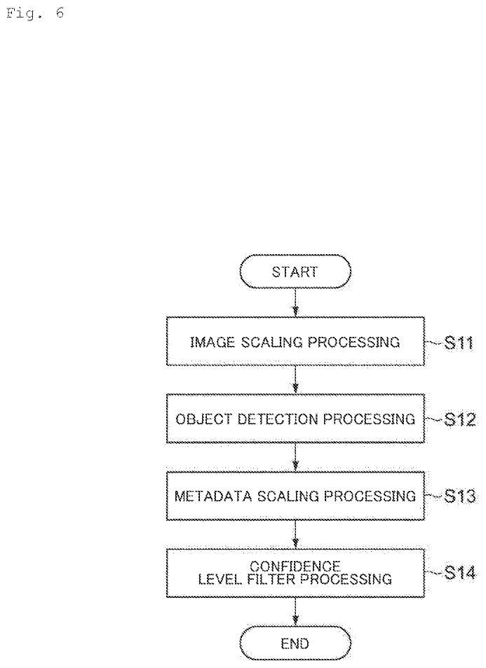

FIG. 6 is a flowchart illustrating details of the entire image processing of step S2 in FIG. 5.

In a step S11, the CPU 11 executes scaling processing to the input image as an image scaling processing unit 111. The scaling process is the above-mentioned process as the function of the image scaling processing unit 111.

Following the step S11, in a step S12, the CPU 11 executes object detection processing to the entire image after the scaling processing is performed as an object detection processing unit 112. The object detection processing is the processing described above as the function of the object detection processing unit 112.

Following the step S12, in a step S13, the CPU 11 executes metadata scaling processing as a metadata scaling processing unit 113. The metadata scaling processing is the processing described above as the function of the metadata scaling processing unit 113.

Following the step S13, in a step S14, the CPU 11 executes confidence level filter processing to the entire image as a confidence level filter processing unit 114. The confidence level filter processing for the entire image is the processing described above as the function of the confidence level filter processing unit 114.

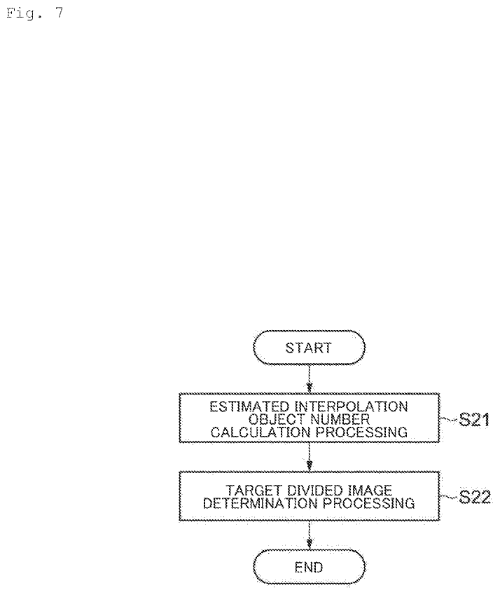

FIG. 7 is a flowchart illustrating details of the divided image narrowing processing of a step S3 in FIG. 5.

In a step S21, the CPU 11 executes estimation interpolation object number calculation processing as an estimation interpolation object number calculation processing unit 121. Details of the estimation interpolation object number calculation processing will be described later.

Following the step S21, in a step S22, the CPU 11 executes object division image determination processing as a target divided image determination processing unit 122. Details of the target divided image determination processing will be described later.

FIG. 7 is a flowchart illustrating details of the divided image processing of a step S4 in FIG. 5.

In a step S31, the CPU 11 executes image division processing to the input image as an image division processing unit 131. The image division processing is the above-mentioned processing as the function of the image division processing unit 131.

Following the step S31, in a step S32, the CPU 11 executes divided image selection processing as a divided image selection processing unit 132. The divided image selection processing is the processing described above as the function of the divided image selection processing unit 132.

Following the step S32, in a step S33, the CPU 11 executes scaling processing on the divided images as an image scaling processing unit 133. The scaling process for the divided image is the above-mentioned process as the function of the image scaling processing unit 133.

Following the step S33, in a step S34, the CPU 11 executes object detection processing to the divided images as an object detection processing unit 134. The object detection processing for the divided images is the processing described above as the function of the object detection processing unit 134.

Following the step S34, in a step S35, the CPU 11 executes metadata adjustment processing as a metadata adjustment processing unit 135. The metadata adjustment processing is the processing described above as the function of the metadata adjustment processing unit 135.

Following the step S35, in a step S36, the CPU 11 executes confidence level filter processing to the divided images as a confidence level filter processing unit 136. The confidence level filter processing for the divided image is the processing described above as the function of the confidence level filter processing unit 136.

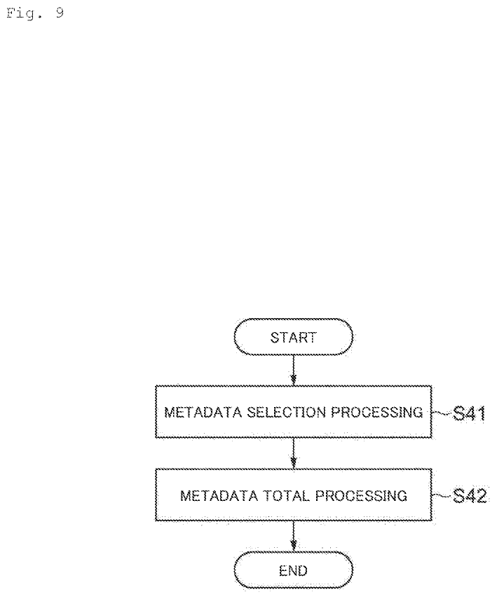

FIG. 9 is a flowchart illustrating details of the synthesis processing step S5 in FIG. 5.

In a step S41, the CPU 11 executes metadata selection processing to the divided images as a metadata selection processing unit 141. The metadata selection processing is the processing described above as the function of the metadata selection processing unit 141.

Following the step S41, in a step S42, the CPU 11 executes metadata total processing as a metadata total processing unit 142. The meta data total processing is the processing described above as the function of the meta data total processing unit 142.

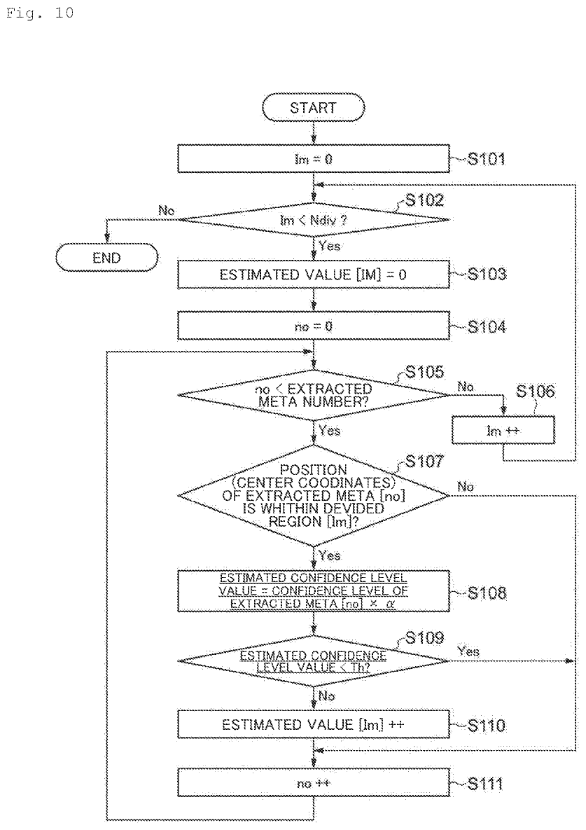

FIG. 10 is a flowchart showing details of the estimated interpolation object number calculation processing.

The CPU 11 first sets a variable Im to 0 in a step S101. Following the step S101, in a step S102, the CPU 11 determines whether the variable Im is less than the image division number N_{div}.

If the variable Im is not less than the image division number N_{div} (step S102; No), the CPU 11 terminates a series of estimated interpolation object number calculation processing. On the other hand, if the variable Im is less than the image division number N_{div} (step S102; Yes), the CPU 11 sets an estimated value [Im] to 0 in a step S103. Following the step S103, in a step S104, the CPU 11 sets a variable no to 0.

Following the step S104, in a step S105, the CPU 11 determines whether the variable no is less than the extracted meta number. The extracted meta number refers to the number of metadata less than the confidence level Th detected by the entire processing unit 110.

In the determination of the step S105, when the variable no is equal to or more than the extracted meta number (step S105; No), in a step S106, the CPU 11 increments the variable Im by one. When the processing of the step S106 is finished, the CPU 11 returns to the processing of the step S102.

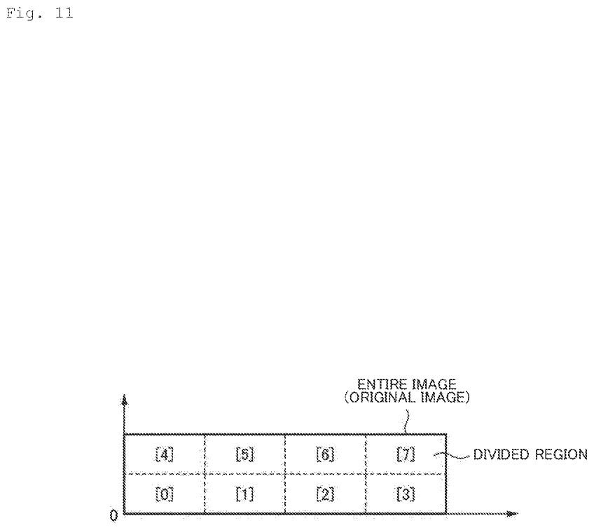

On the other hand, when the variable no is less than the extracted meta number in the determination (step S105; Yes), in a step S107, the CPU 11 determines whether or not the position (central coordinate) of the extracted meta [no] is within the divided area [Im]. As shown in FIG. 11, the divided area refers to the coordinate area of each divided image. The coordinates on the boundary line of the divided areas are made to correspond only to any one of the areas, and they are prevented from being overlapped. Although the entire image is divided into eight in FIG. 11, the number of divisions is not limited to this example.

In the determination of the step S107, when the position (center coordinate) of the extracted meta [no] is within the divided region [Im] (step S107; Yes), in a step S108, the CPU 11 multiplies the confidence level of the extracted meta [no] by a predetermined coefficient α to obtain an expected confidence level value. Here, the coefficient α is a value representing a ratio of improving confidence level by reduction and relaxation of a characteristic portion of the object by division processing compared to the entire processing.

Following the step S108, in a step S109, the CPU 11 determines whether the expected confidence level value obtained in the step S108 is less than a predetermined threshold Th.

In the determination of the step S109, when the expected confidence level value is equal to or more than a predetermined threshold Th (step S109; No), the CPU 11 increments the estimated value [Im] by one in a step S110.

Following the step S110, in a step S111, the CPU 11 increments the variable no by one.

In the determination of the step S107, when the position (center coordinate) of the extracted meta [no] is not within the divided region [Im] (step S107; No), the CPU 11 skips the processing to a step S111. In the determination of the step S109, if the expected confidence level value is less than a predetermined threshold Th (step S109; Yes), the CPU 11 skips the processing to step S111.

The CPU 11 can calculate the estimated value [Im] by executing a series of processes shown in FIG. 10. When the calculation of the estimated value [Im] is completed, in target divided image determination processing in a divided image narrowing unit 120, high-order N_{div} narrow divided images with a large estimated value [Im] (having a large estimated interpolation object number) can be regarded as narrowed divided images so that the number of detected objects becomes maximum.

In the object detection device 10 according to the present embodiment, for example, when the number of divided images N_{div} in a 4K image is 18 and the number of narrowed-down divided images N_{div_narrow} is 2, the amount of calculation in the division processing can be reduced to 2/18 (= 1/9).

Although the object detection device 10 according to the present embodiment is configured to select a narrowed-down image from divided images obtained by dividing an input image, the present disclosure is not limited thereto. The object image area may be extracted from the original input image according to the narrowing-down result of the divided image narrowing unit 120, and output it as a narrowed-down divided image to the object detection processing unit 134 at the subsequent stage. Further, the object detection result from the entire processing unit 110 inputted to the divided image narrowing unit 120 is not the current frame but the result of the immediately preceding frame, and the divided image narrowing unit 120 may narrow the next frame. By using the result of the immediately preceding frame, the processing of the division processing unit 130 can be executed in parallel without waiting for the processing of the entire processing unit 110.

### Second Embodiment

The configuration of the object detection device 10 according to the second embodiment is similar to the configuration of the object detection device 10 according to the first embodiment. In the second embodiment, in the target divided image determination processing in the target divided image determination processing unit 122, upper N_{div_narrow} divided images having a high value obtained by dividing the estimated value calculated by the estimated interpolation object number calculation processing unit 121 by the average estimated value are made to be narrowed down divided images. By narrowing down the divided images in this manner, the object detection device 10 according to the second embodiment can make the detection density between the divided images uniform. The average estimation value is calculated by the estimated interpolation object number calculation processing unit 121.

The average estimation value is a time average value of estimation values for each divided region calculated for each frame, and is a value obtained by, for example, a moving average or an O_{est_avg}=O_{est_avg}+(1−U)O_{est_current} (O_{est_avg}: average estimated value, O_{est_current}: calculated estimate value, u: forgetting factor).

In the object detection device 10 according to the present embodiment, upper N_{div_narrow} divided images having a high value which is obtained by dividing the estimated value by the average estimated value, are made into narrowed divided images, only the divided images having a high estimated value are not continuously selected. In other words, the object detection device 10 according to the present embodiment, the divided images which have a low average estimation value, and are difficult to be selected are also selected, so that the detection density between the divided images can be made uniform.

### Third Embodiment

The object detection device 10 according to a third embodiment of the present disclosure is characterized in that, in addition to calculation of an estimated value for each divided image when the division is made fine, the estimated value for each divided image when the division is made coarse, and a combination of divided images having a large estimated value is made a narrowed-down divided image.

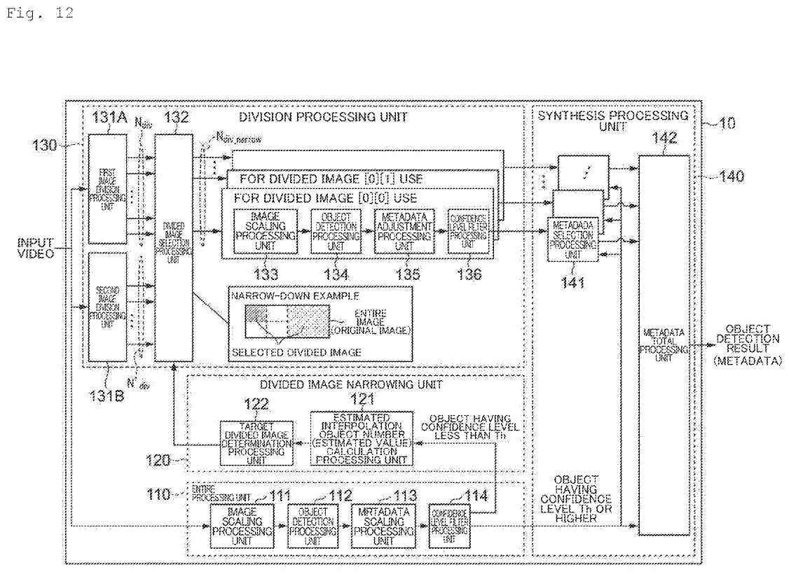

FIG. 12 is a block diagram illustrating an example of a functional configuration of the object detection device 10 according to the embodiment. The respective function configurations are realized when the CPU 11 reads the object detection program stored in the ROM 12 or the storage 14 and develops and performs the read program on the RAM 13.

The object detection device 10 shown in FIG. 12 is different from the object detection device 10 shown in FIG. 4 in that the image division processing unit 131 is divided into a first image division processing unit 131A and a second image division processing unit 131B.

The first image division processing unit 131A divides the input image into N_{div} pieces of divided images as the number N_{w} of divisions in the width direction and the number Nₕ of divisions in the height direction of the input image input as video input, similarly to the image division processing unit 131. The divided image divided by the first image division processing unit 131A is also referred to as a fine particle size divided image.

The second image division processing unit 131B divides an input image inputted as a video input into divided images of N′_{div} pieces (N_{div}>N_{div_narrow}>N′_{div}). That is, the second image division processing unit 131B divides the input image coarser than the first image division processing unit 131A. The divided image divided by the second image division processing unit 131B is also referred to as a coarse particle size divided image.

A divided image narrowing unit 120 calculates an estimated value (coarse grain degree estimated value) in each divided region when the number of divided images is N′_{div} in addition to an estimated value (fine grain degree estimated value) in each divided region when the number of divided images is N_{div} by an estimated interpolation object number calculation processing unit 121. The target divided image determination processing unit 122 outputs, as a narrowed divided image, upper N_{div_narrow} pieces of divided images having a high estimated value among the fine particle size estimated value group and the coarse particle size estimated value group. A division processing unit 130 selects the object division image on the basis of the narrowing-down result by the division image narrowing-down part 120, and performs object detection processing.

In the case where the division is made coarse, the confidence level improved by the division processing is reduced as compared with the case where the division is made fine. Therefore, when calculating the coarse particle size estimation value, the estimated interpolation object number calculation processing unit 121 sets a coefficient to be multiplied by the confidence level of the extracted object to β (β>α).

The object detection device 10 according to the third embodiment can optimize the division of the input image while suppressing the amount of calculation by calculating the estimated value for each divided image when the division is made fine and also calculating the estimated value for each divided image when the division is made coarse.

### Fourth Embodiment

The object detection device 10 according to the fourth embodiment of the present disclosure is characterized in that, as in the third embodiment, the estimated value for each divided image when the division is made rough is calculated, and a combination of divided images having a large estimated value is made a narrowed-down divided image. Further, the object detection device 10 according to the fourth embodiment of the present disclosure is characterized in that the calculated estimated value is dynamically corrected from the difference between the estimated value of the number of interpolated objects and the actual value.

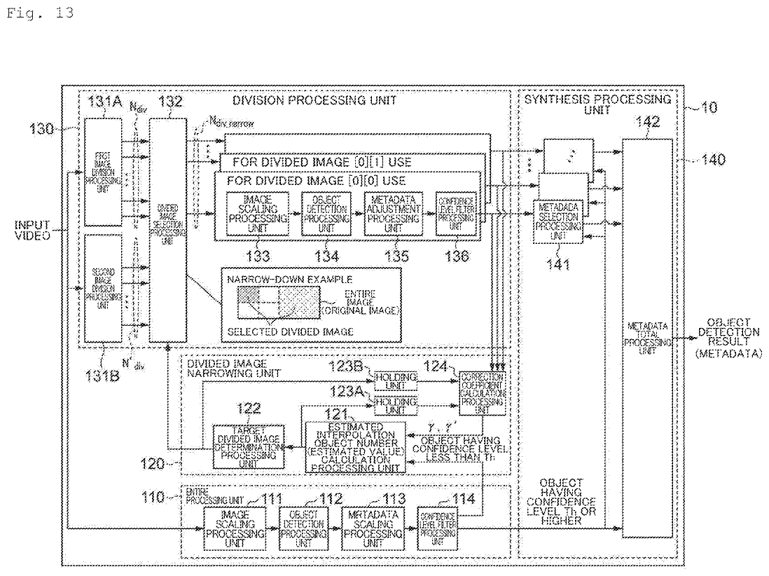

FIG. 13 is a block diagram illustrating an example of a functional configuration of the object detection device 10 according to the embodiment. The respective function configurations are realized when the CPU 11 reads the object detection program stored in the ROM 12 or the storage 14 and develops and performs the read program on the RAM 13.

The object detecting apparatus 10 shown in FIG. 13 is different from the object detecting apparatus 10 shown in FIG. 12 in that holding units 123A and 123B and a correction coefficient calculation processing unit 124 are added to the divided image narrowing section 120.

The holding unit 123A holds the estimated interpolation object number output by the estimated interpolation object number calculation processing unit 121. A holding unit 123B holds an object division image number for identifying the object division image output by the target divided image determination processing unit 122. The correction coefficient calculation processing unit 124 calculates a coefficient used for calculating the expected confidence level value on the basis of the information held by the holding units 123A, 123B. Specifically, when the object detection result of the next frame corresponding to the information held by the holding units 123A and 123B is outputted, the correction coefficient calculation processing unit 124 calculates a difference value between an actual value and an estimated value. The correction coefficient calculation processing unit 124 updates a correction coefficient γ′ when calculating the coarse particle size estimation value when the estimation value is the coarse particle size estimation value, and updates a correction coefficient γ when calculating the fine particle size estimation value when the estimation value is the fine particle size estimation value. The correction coefficient calculation processing unit 124 updates the correction coefficient by the following expressions, respectively.

γ′=u′×d_{coarce} (d_{coarce}=actual value of the estimated value at the time of selecting the coarse particle size divided image−fine particle size estimation value).

γ=u×d_{fine} (d_{fine}=actual value of the estimated value at the time of selecting the fine particle size divided image−coarse particle size estimation value)

u, u′: a predetermined error coefficient of 1 or less

Here, γ is a value common to the fine particle size divided images, and γ′ is a value common to the coarse particle size divided images.

The estimated interpolation object number calculation processing unit 121 calculates, when calculating an estimated value, a value obtained by adding a correction coefficient corresponding to a corresponding division method in addition to the coarse particle size estimation value and the fine particle size estimation value described in the third embodiment, target division image determination processing is performed.

The object detection device 10 according to the fourth embodiment can optimize the division of the input image while suppressing the amount of calculation by calculating the estimated value for each divided image when the division is made fine and also calculating the estimated value for each divided image when the division is made coarse. Further, the object detection device 10 according to the fourth embodiment can improve the accuracy of the expected confidence level value by updating the coefficient used for calculating the expected confidence level value by using the difference value between the actual value and the estimated value.

In the metadata selection processing of the object detection device 10 in each of the above embodiments, two-stage threshold processing may be performed. Specifically, even if the degree of overlap is equal to or greater than a first threshold, it may be determined whether or not a ratio of an area of a quadrangular frame BB2 included in metadata of the divided image to an area of a quadrangular frame BB1 of an object included in metadata of the entire image is equal to or less than a second threshold. When the ratio is equal to or less than the second threshold, it is determined that the attribute information of the metadata MD1 of the divided image is not common to the attribute information of the metadata MD2 of the entire image, and the result may be a target of interpolation processing by the synthesis processing unit 140. With consideration given to the area ratio between objects as well as the overlap degree, the object detection device 10 excludes the attribute information in the metadata of the divided image and in the metadata of the entire image from the interpolation targets through two-stage threshold value processing.

In contrast to this, the object detection device 10 in above respective embodiments, in the metadata selection processing, furthermore, may determine whether or not attribute information having an attribute value that does not match any of the attribute values included in the metadata of the entire image is included in the metadata of the divided image. If the metadata includes attribute information having an attribute value that does not match, the object detection device 10 compares the area of the quadrangular frame BB2 of the object included in the metadata of the divided image and the area of the region of the input image corresponding to the quadrangular frame BB2. Thus, the object detection device 10 may eliminate the overlap of the metadata included in the divided image and the entire image, based on the overlap degree and the area ratio between the objects.

The object detection device 10, by excluding the overlap between metadata included in the divided image and metadata included in the entire image, can exclude metadata related to erroneous detection of an object accompanying the division of the input image by the division processing unit 130. Also, the object detection device 10, by excluding the overlap between metadata included in the divided image and metadata included in the entire image, can interpolate an object having a relatively small size, which could not be detected by the entire processing unit 110 in the entire image obtained by reducing the size of the input image, based on the metadata of the divided image.

Note that the object detection processing performed by reading the software (program) with the CPU in the above respective embodiments may be performed by various processors other than the CPU. Examples of processors used in such cases include a PLD (Programmable Logic Device) such as a FPGA (Field-Programmable Gate Array) of which a circuit configuration can be changed after production and a dedicated electrical circuit that is a processor including a circuit configuration such as an ASIC (Application Specific Integrated Circuit) that is designed to execute specific processing. Further, the object identification processing may be performed by one of the various processors or may be performed by a combination of two or more of the same type or different types of the processors (for example, a plurality of FPGAs, a combination of a CPU and a FPGA, or the like). Furthermore, more specifically, the hardware structure of these various processors is an electrical circuit combining circuit elements such as semiconductor elements.

Further, the above respective embodiments describe a mode in which the object identification program is stored (installed) in advance in the storage 14, but the provision of the program is not limited to this mode. The program may also be provided in a state where the program is stored in a non-transitory storage medium such as a CD-ROM (Compact Disk Read Only Memory), a DVD-ROM (Digital Versatile Disk Read Only Memory), or a USB (Universal Serial Bus) memory. In addition, the program may be downloaded from an external device over a network.

The following additional remarks are disclosed in relation to the embodiments described above.

### (Additional Remark 1)

An object detection device that outputs metadata including at least an attribute, confidence level, center coordinates of an object included in an input image, and a frame surrounding the object from the input image, comprising:
a memory; and
at least one processor that is connected to the memory;
wherein the processor
in an object detection method for outputting, from an input image, metadata including at least an attribute, confidence level, center coordinates of an object included in the input image, and a frame surrounding the object,
performs object detection processing by scaling the input image to obtain first metadata for the entire input image, narrows down a group of divided images obtained by dividing the input image into a predetermined number of selected divided images,
performs object detection processing on each of the selected divided images to obtain second metadata for each of the selected divided images,
removes the second metadata overlapping the obtained first metadata, synthesize the unremoved first metadata with the obtained first metadata,
and outputs the metadata.

### (Additional Remark 2)

A non-transitory storage medium storing a program executable by a computer to execute an object detection processing of outputting, from an input image, metadata including at least an attribute, a confidence level, a center coordinate, and a frame surrounding the object included in the input image, wherein
the object detection processing:
in an object detection method for outputting, from an input image, metadata including at least an attribute, confidence level, center coordinates of an object included in the input image, and a frame surrounding the object,
performs object detection processing by scaling the input image to obtain first metadata for the entire input image, narrows down a group of divided images obtained by dividing the input image into a predetermined number of selected divided images,
performs object detection processing on each of the selected divided images to obtain second metadata for each of the selected divided images,
removes the second metadata overlapping the obtained first metadata, synthesize the unremoved first metadata with the obtained first metadata,
and outputs the metadata.

### REFERENCE SIGNS LIST

10 Object detection device
110 Entire processing unit
120 Divided image narrowing unit
130 Division processing unit
140 Synthesis processing unit

1. An object detection device comprising a processor configured to execute operations comprising:
receiving first metadata for an input image by scaling the input image and performing object detection processing;
dividing the input image into a predetermined number of selected divided images to determining a divided image group,
detecting each of the divided images to obtain second metadata for each of the selected divided images;
removing the second metadata, overlapping the first metadata;
generating output metadata, by synthesizing the remaining portion of the first metadata after the removing of the received second metadata and the received first metadata; and
outputting the output metadata.

2. The object detection processing device according to claim 1, wherein the dividing further comprises:
calculating, for each of the divided images, an estimated value of the number of the second metadata that does not overlap the first metadata, wherein the estimation value includes a value obtained by totalizing, for each region where the divided image is located, the number of first metadata in which the confidence level is less than a threshold and a value obtained by multiplying the confidence level by a predetermined coefficient is equal to or greater than a threshold among the first metadata.

3. The object detection device according to claim 2, wherein the dividing further comprises:
selecting the selected divided images in order of the divided images having the higher estimated value until the number of selected images is reached to a predetermined number.

4. The object detection device according to claim 2, wherein the dividing further comprises:
selecting selects the selected divided images in order from the divided images having a high value obtained by dividing the estimated value by an average value of the estimated values until the number of selected images is reached to a predetermined number.

5. The object detection device according to claim 2, wherein the dividing further comprises:
calculating the estimated value for each of a first divided image group divided into a first size and a second divided image group divided into a second size larger than the first size, and narrows down based on the calculated estimated value into a predetermined number of selected divided images.

6. The object detection device according to claim 5, wherein the dividing further comprises:
updating a coefficient used for calculation of the estimated value by using a difference between the estimated value calculated for each of the first divided image group and the second divided image group and a result of the object detection.

7. An object detection method method comprising:
scaling the input image;
receiving, based on the scaled input image, first metadata for an input image;
dividing the input image into a predetermined number of selected divided images;
receiving second metadata for each of the selected divided images;
removing the received second metadata overlapping the obtained first metadata from the first metadata;
generating, output metadata by synthesizing the remaining portion of the first metadata after the removing the received second data with the received first metadata; and
outputting the output metadata.

8. A computer-readable non-transitory recording medium storing computer-executable program instructions that when executed by a processor cause a computer system to execute operations comprising:
receiving, based on the scaled input image, first metadata for an input image;
dividing the input image into a predetermined number of selected divided images;
receiving second metadata for each of the selected divided images;
removing the received second metadata overlapping the obtained first metadata;
generating output metadata, by synthesizing the remaining portion of the first metadata after the removing the received second data with the received first metadata; and
outputting the output metadata.
